(19) United States
(12) Patent Application Publication
(10) Pub. No.: US 2010/0052479 A1
(43) Pub. Date: Mar. 4, 2010

(54) REMOTE ULTRASONIC TRANSDUCER SYSTEM

(75) Inventors: Rene Breeuwer, Delft (NL); Anne-Jan Faber, Veldhoven (NL); Mathias Hendrikus Maria Rongen, Eindhoven (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Nederlandse Organisatie voor toegepast- natuurwetenschappelijk Onderzoek TNO, Delft (NL)

(21) Appl. No.: 12/514,764

(22) PCT Filed: Nov. 15, 2007
(86) PCT No.: PCT/NL07/50567

§ 371 Date: Aug. 3, 2009

(30) Foreign Application Priority Data
Nov. 15, 2006 (EP) 06077025.2

(51) Int. Cl. B06B 3/00; B06B 1/06

(52) U.S. Cl. 310/335

(57) ABSTRACT

An ultrasonic transducer system is provided for monitoring or treating a liquid medium (5) within a processing vessel, (8) such as a melting tank or a vessel with an chemically aggressive liquid medium. The purpose of monitoring can be characterization of flow velocities, melt surface levels and inhomogeneities in the liquid medium. The ultrasonic transducer system comprises at least one electro-acoustical transducer element (1) and an acoustic waveguide (3,4). A first extremity of the acoustic waveguide is connected to the transducer element outside the processing vessel, while a second extremity of the acoustic waveguide extends inside the processing vessel. The acoustic waveguide comprises one or more cavities (4) which extend throughout the whole acoustic waveguide's length. The cavities may be closed (6) at the acoustic waveguide's second extremity. A surface acoustic wave is excited on the wall of the one or more cavities and transmitted to the second extremity, which is in contact with the liquid medium. From this second extremity the acoustic signal is transmitted into the medium. Thus, it is avoided to place the transducer into contact with the liquid medium and at the same time effects of external attachments to the waveguide is minimized.

### FIELD OF THE INVENTION

The invention concerns an ultrasonic transducer system for monitoring or treating a medium within a processing room, such as a processing vessel and more specifically a melting tank or a tank containing a chemically aggressive medium, the ultrasonic transducer system comprising at least one electro-acoustical transducer element and an acoustic waveguide.

### BACKGROUND

Ultrasonic techniques are very suitable for inspection of optically opaque liquid media, for instance for detection and classification of solid particles, gas bubbles and other inhomogeneities. Moreover, power ultrasonic techniques allow treating such inhomogeneities, for example by manipulating, coagulating, mixing or dissolving.

To realize sufficient acoustic transmission into the liquid medium, contact between a source of acoustic signals and the liquid medium is desirable. The application of these techniques in certain media, such as high temperature glass melts or metal melts or chemically aggressive media is hampered because available transducers are not able to directly withstand contact with these media. To solve this problem, rugged rods have been employed as acoustic waveguides that act as a buffer between the contact to the aggressive medium and the elementary transducer. However, use of such rods has been found to lead to problems in terms of dispersion and reflection of acoustic waves along the rod.

In all the relevant applications the ultrasound is generated by an active device, the transducer, converting electrical energy into ultrasound. Such a transducer is commonly based on a piezoelectric material, although other principles may be used, for instance, capacitive, electromagnetic or magnetostrictive transduction. In order to be able to detect small particles, small wavelengths and, therefore, high ultrasonic frequencies are required. For power ultrasonic techniques, lower ultrasonic frequencies are generally used and it is necessary to transport significant amounts of power, requiring larger contact areas.

In many cases, the transducer itself is not able to directly withstand contact with the medium under investigation, because of its temperature (such as in glass or metal melts) or chemical aggressiveness.

Therefore, in such cases, ultrasonic waveguide rods have been employed to act as a buffer between the aggressive medium and the elementary transducer. In the past, simple cylindrical rods have been used frequently. However, depending on material and dimensions, axial ultrasonic propagation through a general cylindrical rod is far from ideal, showing effects such as dispersion (frequency-dependent propagation velocity). A significant amount of dispersion is unacceptable as it distorts the shape of an ultrasonic pulse, rendering, for instance, particle detection impossible.

For larger diameter-wavelength ratio's, even distinct multipath echo's (single input pulses generating several responses) may occur, which is quite unacceptable for most applications.

Three basic approaches have been used in the past to reduce these detrimental effects:
1. Using waveguides with very small diameters (with respect to the wavelength);
2. Using non-cylindrical shapes (for instance biconical);
3. Using inhomogeneous waveguides (with radius-dependent properties).

Ad 1. The small diameter required by the first approach (for instance, for a 10 MHz centre frequency alumina waveguide, a diameter <0.2 mm) would not possess adequate mechanical rigidity and ruggedness. Also, as the acoustic power that can be generated is proportional to the cross-sectional area, for most applications such a thin rod would not allow generating adequate acoustical power. Finally, the ultrasonic beam radiated by such a small aperture diverges strongly (almost hemispherically), causing a rapid decrease in intensity with distance and cannot be focused.

Ad 2. The second approach can only yield a minor degree of improvement, and for relatively short waveguides.

Ad 3. The third approach, analogous to that used in optical fiber waveguides, has more potential. A clad rod, consisting of a low-velocity core with a higher velocity cladding, could work well. The best results could be obtained with a continuous variation of the sound speed from the center of the rod out to the periphery. For the intended range of applications, the main difficulty of this technique is to find materials and suitable cladding/bonding techniques, able to work at operational temperatures in the range of 1600° C. and to maintain a perfect bond over multiple thermal cycles.

A common drawback of all three approaches is any contact or fouling on the outside of the rod directly affecting the wave propagation, so that, for instance, immersing the rod over some distance into a liquid to carry out measurements below the surface drastically changes the acoustic output. Due to the existence of radial displacements at the outside of the rod, acoustic energy is radiated from the outside into the fluid and, moreover, acoustic surface waves are generated at the liquid surface. By the same token, embedding the rod in any material, such as insulation, or passing it through a vessel wall, will hamper its operation.

Power ultrasonic installations generally operate at a single frequency, and thus dispersion is not much of a concern. However, in scaling up power ultrasonic applications to large industrial installations such as steel or glass production, the diameters of coupling rods suitable from an ultrasonic viewpoint (either much smaller or much larger than the wavelength frequently fall outside the range that is acceptable for mechanical (ruggedness) or operational (power delivery capacity) reasons.

U.S. Pat. No. 4,676,663 discloses a temperature sensor for an oven, comprising a hollow ultrasonic waveguide and a sensor at the end of the waveguide. The sensor is made up of discontinuities in the waveguide, which give rise to interference between reflections of ultrasonic waves at the tip of the waveguide, dependent on the distance between the discontinuities, which in turn depends on temperature in the oven. The walls of the waveguide are made sufficiently thick so that supporting clamps on the outside have no effect on wave propagation. The ultrasonic waves stay inside the waveguide, also at its tip, which is adequate to perform temperature measurement. The document does not describe detection of flows, liquid surface levels and inhomogeneities such as solid particles, gas bubbles and other inhomogeneities in a liquid outside the sensor.

Optical, not ultrasonic, sensors that use optical waveguides in thermometers are known from JP 07184866 and EP 875 197.

JP2006165005 discloses an ultrasonic vibration detector with a conically shaped wave shielding member with a waveguiding hole at its tip, to allow ultrasonic waves to pass in and out.

U.S. Pat. No. 5,606,297 discloses a waveguide for projecting an acoustic wave toward a target area, for example to detect moving vehicles. A waveguide comprising a cluster of a plurality of tubular channels is used which allow gas pressure waves to pass from an ultrasound energy source out to the target area in a directional beam pattern.

### SUMMARY

One aim is to provide an ultrasonic transducer system for monitoring material features of a liquid or treating such features of a liquid within a processing vessel containing an aggressive medium.

In an embodiment processing vessel with a very hot medium such as a melting tank or the processing vessel may be a tank containing a chemically aggressive medium. In an embodiment features such as inhomogeneities in the liquid, flow velocities or liquid surface levels may be monitored or treated.

An ultrasonic transducer system is provided comprising an electro-acoustical transducer element and a waveguide according to claim 1.

The first extremity of the waveguide may be located outside the processing vessel and a second extremity of the waveguide is located inside the processing vessel. At the interior of the waveguide there is a number of (i.e. at least one) cavities which mainly extend throughout the whole waveguide's length. At least part of said number of cavities may be closed at the waveguide's second extremity (viz. inside the processing vessel). The transducer element is coupled to the waveguide remote from the second extremity, for example at the first extremity.

The novel ultrasonic transducer system employs ultrasonic surface waves on the free and smooth inner surface of a solid waveguide. On semi-infinite solids such waves, also referred to as Rayleigh waves, are nondispersive and can travel undistorted and with little attenuation over long distances.

A method is provided for wherein the extremity of a waveguide with an interior cavity is placed in contact with a liquid medium in a processing vessel. Herein acoustic surface waves are passed along the interior cavity to the extremity of the waveguide from where they are coupled to the liquid through a closure. Thus, on one hand an acoustic signal can be generated for example in a melt in a melting tank or in a chemically aggressive medium without having to place a transducer in contact with the liquid medium and on the other hand transmission of the acoustic waves to the extremity is not, or hardly, affected by attachments to the outside of the acoustic waveguide. The acoustic waveguide may extend into the liquid over some distance.

### BRIEF DESCRIPTION OF THE DRAWING

Exemplary embodiments will be described using the following figures.

FIG. 1 schematically shows an ultrasonic transducer system; FIGS. 2 through 10 show optional configurations.

The various figures show an embodiment of an ultrasonic transducer system for monitoring or treating a medium 5 within a processing vessel, the ultrasonic transducer system comprising an electro-acoustical transducer element 1, electrically connected by connection wires 2, and a waveguide. The first extremity of the waveguide is connected to the transducer element 1 outside the processing vessel, while a second extremity of the waveguide extends inside the processing vessel. In operation, the second extremity is in contact with the liquid medium in the processing vessel. For good contact and to avoid effects of the liquid surface, the second extremity may even extend to some depth within the liquid, for example over at least a millimetre and preferably a few millimetres, e.g two millimetres and possibly ten millimetres or more. The waveguide consists of a rod 3 and a number (one or more) of cavities or bores 4 in rod 3, which substantially extend throughout the entire length of the waveguide. The bores 4, or at least part of them, may be closed, by means of a closure 6, at the waveguide's second extremity. Closure 6 serves to prevent liquid from entering bore or bores 4 from processing vessel 8. At the same time it serves to pass at least part of the ultrasonic signal between bore or bores 4 and the liquid in processing vessel 8.

The transducer 1 may be mounted in a wall 7 of the processing vessel 8. The transducer element 1 excites an ultrasonic signal into the cavity 4, which is transferred along the inner surfaces of the cavity 4 having a single mode (mono mode) wavestructure. By far the biggest part of the energy entered into the cavity 4 will be dissipated via the closed extremity 6 into the medium 5, while only a negligible fraction will leak to the side

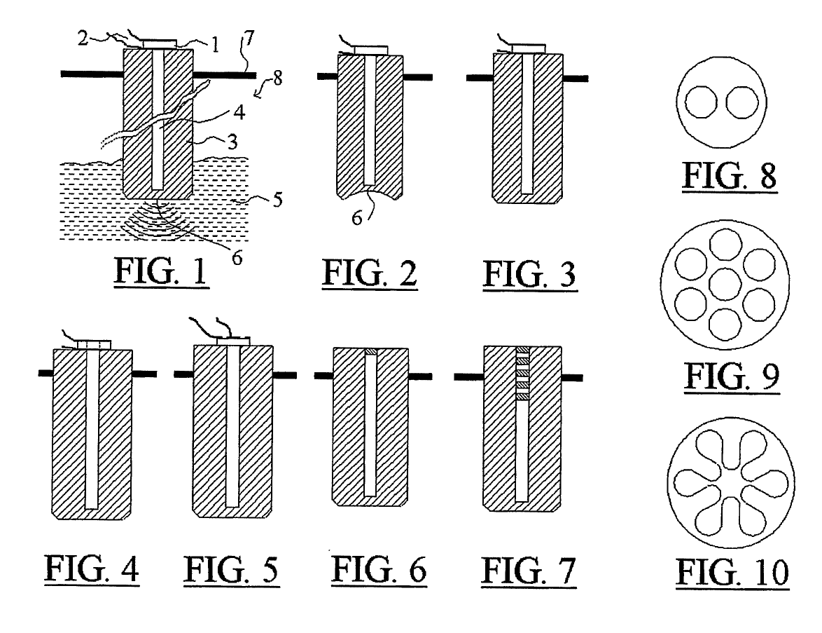

For the sake of clarity, the simplest implementation will be discussed here first, employing the inner surface of a hollow rod (for instance a thick-walled cylinder, capillary or tube) for the propagation surface schematically, the configuration is shown in FIG. 1.

The transducer 1 shown at the top converts electrical into ultrasonic energy. This energy then travels along the waveguide as a surface wave, essentially contained in a thin surface layer surrounding the central bore 4. At the closure 6 of the waveguide, the energy in the waveguide converts into an ultrasonic compression wave which is excited in the liquid medium 5.

As will be appreciated, the degree of ultrasonic coupling between bore or bores 4 and liquid medium 5 may depend on the thickness of closure 6 between the liquid and bore or bores 4. A suitable thickness that provides for blocking of liquid and coupling acoustic signals may be selected experimentally.

Any medium present inside the bore 4 will cause some energy to leak from the surface wave into it. Therefore, ideally, the bore 4 would be evacuated. However, for all but the most demanding practical applications, the presence of atmospheric air (or most other gases) will be entirely acceptable. Another option is to fill the cavity (or cavities in other topologies, see e.g. FIG. 9) with e.g. an open or closed cell foam.

At the far end 6 of the rod 3, the bore 4 is sealed, preventing the liquid medium 5 from entering the bore. The opposite transducer end may be closed off as well, to allow evacuation or to improve matching the transducer to the waveguide.

For application in very high temperature melts (such a glass or metals, at temperatures above 500 degrees centigrades, for example at 780 degrees centigrade (aluminum melts) or between 1400 and 1700 degrees centigrade (for glass and steel melts)), the transducer element 1 is placed in a relatively cool zone, away from the melt. Naturally, the distance required to lower the temperature to an acceptable level may be reduced by screening, insulating and air- or liquid-cooling parts of the waveguide. The absence of significant displacement amplitudes at the outside of the waveguide facilitates this by permitting direct attachment of screens and packing the guide in insulating material, while at the same time preventing the insertion depth into the melt from affecting the ultrasonic signals.

The use of cylindrical rather than plane surfaces does introduce some dispersion, but this can be limited to any desired degree by increasing the radius of curvature.

In the basic cylindrical bore configuration, closing the bore at the far end 6 of the waveguide by a thin, acoustically transparent cover would create an annular sound source in the target liquid with an inner diameter equal to the bore 4. The effective width of the annulus is of the order of the wavelength of the surface wave in the waveguide material. The radiated field of such an annular source has maxima on its axis, and the beam width is determined by the dimensions and the ultrasonic wavelength in the medium. As the radius of the annulus and the frequency may be chosen independently, many options for suitable sensor designs are open.

However, the cover may also possess a specific thickness and/or be made of a different material and/or several layers to improve converting the guided waves propagating along the bore to compressional waves in the liquid, similar to the matching layers employed in conventional ultrasonic transducers.

The cover may also be formed in a certain shape, acting as a lens, to affect the spreading of the ultrasonic beam in the liquid by focusing or defocusing, as shown schematically in FIG. 2 for the example of concave spherical focusing.

As mentioned earlier, various options exist for the physical principle employed to convert electrical to acoustical energy and vice versa. It can be accomplished, for instance, capacitively, electromagnetically or magnetostrictively. However, piezoelectric transduction dominates the field of ultrasonic applications.

For the current type of application, various topology options exist. Some examples will be given below. In this discussion, the active element is shown as simple homogeneous disk of piezoelectric material, provided with electrodes on both end faces. However, it may also be a composite of passive and piezo material elements, for instance a sandwich of piezo material with layers of passive materials on one or both end faces, or an assembly of concentric annuli of passive and piezo materials. Piezocomposites where the passive and active fractions are more finely interspersed are also employed in many cases.

The preferred composition and dimensioning of the active element and the choice of the optimum topology depend heavily on the sensor specifications and the material properties and dimensions of the waveguide.

The simplest topology, shown in FIG. 3, uses a simple thickness-expander element to create axial vibrations. It excites the axial component of the Rayleigh wave. In general, Rayleigh waves have an axial and radial component; the vibration mode of individual particles at the surface can be visualized by an elliptical path. The amplitude of the axial component decays away from the free surface. Therefore, the active element diameter is such that it covers an annulus with a width of approximately one wavelength around the bore.

The thickness of the element determines the transducer centre frequency (the thickness of the element is equal to a half wavelength at the resonant frequency). For efficient energy conversion, the diameter/thickness ratio of the element should preferably be 5 or more.

A disadvantage of this topology is the free area of the element above the bore. This acts as an acoustic short. Although this area of the element could be loaded by a suitable impedance, another option is an element in the shape of an annulus as illustrated in FIG. 4. In this design, certain aspect ratios for the annulus will not provide efficient energy conversion. Another drawback of this (and the previous) topology is that it generates longitudinal waves as well as Rayleigh waves, causing spurious echos. The strength of these depends on the material properties, the frequency and the dimensions.

Active elements exciting in the radial direction are preferable, as they generate very small axial components. An example is shown in FIG. 5. The active element in this topology is only electroded on the top side. A concentric ring, covering the area to excite, is removed from the electrode. Due to the electric field gradient in the disc, this area is excited in radial direction.

Another excitation topology option is a radially expanding disk mounted within the bore as shown in FIG. 6. At the excitation center frequency, the disk diameter equals half a wavelength. The optimum thickness of the disk is determined by a two of factors:
The disk aspect ratio (for energy conversion efficiency)
The Rayleigh wavelength in the waveguide (it should be less than a quarter wavelength)

For an increased excitation level, several elements could be used as an axial array, as shown in FIG. 7. If spaced at half wavelength intervals and excited in opposite phase the individual signals interfere constructively, yielding a stronger signal, albeit with somewhat reduced bandwidth.

The excitation could be optimized if the elements were excited by individual signals generated by arbitrary wave generators. In this case, their relative distance can also be chosen freely.

The principle of a waveguide propagating ultrasonic energy along free internal surfaces may be implemented in many other ways than the basic cylinder with a single coaxial bore. For the sake of clarity, the previous discussion has referred only to cylindrical hollow waveguides. However, as the actual guide is the surface of the bore, and if the wall thickness is adequate, the shape of the outside has very little impact. It may be non-coaxial, rectangular or can be used for attachments. A few other options are identified below.

In practical ultrasonic inspection, frequently separate transmit and receive (pitch-catch) transducers may be employed. This may be realized by dual bores in a single waveguide, as is shown in FIG. 8. each bore may have its own transducer element, e.g. one used as transmitter, the other as receiver element. This option offers a mechanically rugged and simple sensor option for realizing a high frequency pitch-catch pair of transducers with excellent relative alignment. The bores could be arranged at an angle to create a confocal transducer.

Of course, three or four bores are also possible, see FIG. 9. With a confocal region, this would, for instance, allow the measurement of three-dimensional flow vectors of passing particles.

For industrial applications, large power flows may be required. Given a certain frequency, a hollow cylindrical waveguide would allow to create any transport area by increasing the radius. In addition, the construction would be quite rugged. However, with increasing radius, the ratio of the excited area decreases as a fraction of the total area covered by the waveguide. This problem can be solved by the multibore configuration, shown in FIG. 9. Other options exist too, as illustrated in FIG. 10.

As many waveguide materials are able to support higher operational stresses than piezoelectric materials, hollow conical waveguides may be used to concentrate the energy from a large transducer element to a smaller excitation area.

Instead of a cylindrical bore, other regular or irregular closed cross-sections are possible, for instance triangular, square or hexagonal. Separate transducers could be employed to independently generate and detect waves propagating along the faces of these cross-sections. Multi-bore configurations open the opportunity for two- or three-dimensional localization or flow vector measurement. Electronic steering of the compound ultrasonic beam would also be an option. Subdividing a transducer element into a number of smaller transducer elements is also possible on an annular element.

1. Ultrasonic transducer system comprising
a processing vessel for a liquid medium,
at least one electro-acoustical transducer element configured to generate an acoustic wave, and
an acoustic waveguide having a first extremity, a second extremity and at least one interior cavity which mainly extends throughout the waveguide's length between the first extremity and the second extremity, the first extremity being located outside the processing vessel, the second extremity being located inside the processing vessel at a location for contacting the liquid medium, the electro-acoustical transducer element being coupled to the at least one interior cavity remote from the second extremity, the acoustic waveguide comprising a closure at the second extremity configured to allow at least part of the acoustic wave to pass into the liquid medium and to block the liquid medium from entering the at least one interior cavity.

2. Ultrasonic transducer system according to claim 1, wherein the electro-acoustical transducer element is coupled to the at least one interior cavity at the first extremity.

3. Ultrasonic transducer system according to claim 2, the closure of the second extremity having a concave surface shape directed towards the processing vessel.

4. Ultrasonic transducer system according to claim 1, wherein the at least one cavity has a conical shape.

5. Ultrasonic transducer system according to claim 1, wherein the at least one transducer element comprises electrodes at mutually opposite sides of the transducer element.

6. Ultrasonic transducer system according to claim 1, wherein the at least one transducer elements comprises concentric electrodes at one side of the transducer element.

7. Ultrasonic transducer system according to claim 1, wherein one or more transducer elements are located inside at least one cavity.

8. A method of monitoring and/or treating features of a liquid medium in a processing vessel, the method comprising
providing an acoustic waveguide with an extremity in contact with the liquid medium in the processing vessel, the acoustic waveguide having an interior cavity that mainly extends throughout the whole waveguide's length to said extremity, the acoustic waveguide comprising a closure at the extremity;
exciting an acoustic surface wave on an interior surface of the interior cavity, remote from the liquid medium;
passing the acoustic surface wave along the surface of the interior cavity to the extremity and via the closure into the liquid medium.

9. A method according to claim 8, wherein a part of the acoustic waveguide that ends at said extremity is located in the liquid medium, at a depth of at least one millimetre from a surface of the liquid medium.

10. A method according to claim 8, wherein the processing vessel is a melting tank and the liquid medium is a melt.

11. A method according to claim 8, wherein a temperature of the liquid medium is at least 500 degrees centigrade.
Page 3 of 4
